(19) United States
(12) Patent Application Publication
(10) Pub. No.: US 2010/0124233 A1
(43) Pub. Date: May 20, 2010

(54) METHOD FOR SENDING MESSAGE, ACCESS ROUTER AND DATA CACHE SYSTEM

(75) Inventors: Guangyu SHI, Shenzhen (CN); Liufei WEN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/621,253

(22) Filed: Nov. 18, 2009

(30) Foreign Application Priority Data
Nov. 20, 2008 (CN) 200810226940.7

(51) Int. Cl. H04L 12/56

(52) U.S. Cl. 370/401

(57) ABSTRACT

The disclosure relates to a method for sending a message, an access router, and a data cache system. The method for sending a message includes: sending a data request received by the access router to a gateway node in the home routing area of the access router; receiving location information from the gateway node, where the location information identifies a data cache node obtained according to the data request, and obtaining information about the cost of routing from the access router to the data cache node according to the location information; and sending a data obtaining request to the data cache node, where the data obtaining request carries the routing cost information. The method for sending a message, the access router, and the data cache system provided herein utilize the radio bandwidth efficiently and improve the network throughput.

### CROSS-REFERENCE TO RELATED APPLICATIONS

This application claims priority to Chinese Patent Application No. 200810226940.7, filed Nov. 20, 2008, which is hereby incorporated by reference in its entirety.

### FIELD OF THE INVENTION

The disclosure relates to computer network technologies, and in particular, to a method for sending a message, an access router, and a data cache system.

### BACKGROUND OF THE INVENTION

Radio mesh networks are commonly used for Internet access due to cost-efficiency and easy deployment. However, because radio channels are public, radio mesh networks are vulnerable to data congestion at the gateway node, which forms a bottleneck and restricts the network throughput.

Research shows that data traffic of Internet access is localized. Therefore, a web page cache technology is proposed. Through traffic localization, this technology reduces the data traffic of the Internet access gateway, and relieves the bottleneck of the radio access network. The Peer-to-Peer (P2P) cache system combines the traditional cache principles with the P2P application. The basic conception of the P2P cache system is: The P2P content is cached at the network edge, and the cached content serves the subsequent P2P request to filter out repeated P2P contents. FIG. 1 is a schematic diagram of a P2P cache system in the conventional art. First, the peer node (node A) requests to download resource X. The gateway node of the peer node (node A) forwards the download request to the P2P cache device. By querying the cache, this cache device finds that the resource is not hit. Therefore, the cache device forwards the download request to peer node C that stores this resource on the Internet. Finally, peer node A accesses peer node C to obtain resource X. When being sent to peer node A, resource X passes through the cache device and is cached. When peer node B sends a request for downloading resource X again, the download request is also guided to the cache device. At this time, the cache is hit, and the cache device forwards the resource to peer node B directly.

The radio mesh network is combined with the P2P cache system. Each router is capable of caching data. Through the data cache function of the router, the data congestion ratio of the gateway node is reduced, and the data throughput of the user node is improved. The conception of the Broadcast Cache selection Protocol (per-hop BCP) is: Each mesh router acts as a cache device and caches the routed data, and the requesting node obtains the information about the location of the cached data through broadcast of limited hops. If the access router of the user has not hit the data request of the user, the access router sends a broadcast request whose Time to Live (TTL) is “K+2”, where K is the minimum number of hops from the access router to the gateway. If the data exists in the router cache which receives the broadcast, a response about hit data is returned to the access router. The access router selects the best path to obtain the data according to the received response.

In the process of implementing the disclosure, the inventor finds at least these defects in the conventional art: The access router needs to obtain the information about the location of the cached data through routing broadcast; the channels in the radio mesh network are shared resources, and broadcast messages lead to huge consumption of resources; moreover, the default TTL is K+2 hops when the access router sends a broadcast request to request the data, and consequently, the broadcast request of the router near the gateway node is unable to reach a farther adjacent node of the router, and the data request scope is small; due to mutual interference on channels between nodes and different load extents of nodes, the selected best path is not necessarily the best path in the process of obtaining data, and consequently, the utilization of channels is low.

### SUMMARY OF THE INVENTION

Embodiments of the disclosure provide a method for sending a message, an access router, and a data cache system to utilize the radio bandwidth efficiently and maximize the data throughput of a user.

A method for sending a message in an embodiment of the disclosure includes: (1) sending a data request received by an access router to a gateway node in the home routing area of the access router; (2) receiving location information from the gateway node, where the location information identifies a data cache node obtained according to the data request, and obtaining information about the cost of routing from the access router to the data cache node according to the location information; and (3) sending a data obtaining request to the data cache node, where the data obtaining request carries the routing cost information.

A method for sending data in an embodiment of the disclosure includes: (1) receiving a data obtaining request from an access router, where the data obtaining request carries information about the cost of routing from the access router to a data cache node; and (2) sending data corresponding to the data obtaining request to the access router, where the data carries the routing cost information.

Another method for sending data in an embodiment of the disclosure includes: (1) receiving data sent by a data cache node to an access router, where the data carries information about the cost of routing from the access router to the data cache node; (2) determining information about the sending priority of the data according to the routing cost information; and (3) sending the data according to the sending priority information.

An access router provided in an embodiment of the disclosure includes: (1) a data request forwarding module, adapted to send a data request received by the access router to a gateway node in the home routing area of the access router; (2) a routing cost obtaining module, adapted to: receive location information from the gateway node, where the location information identifies a data cache node obtained according to the data request, and obtain information about the cost of routing from the access router to the data cache node according to the location information; and (3) a data obtaining request sending module, connected to the routing cost obtaining module and adapted to: send a data obtaining request to the data cache node, where the data obtaining request carries the routing cost information.

A data cache node provided in an embodiment of the disclosure includes: (1) a data obtaining request receiving module, adapted to: receive a data obtaining request from an access router, where the data obtaining request carries information about the cost of routing from the access router to the data cache node; and (2) a data sending module, adapted to send the data to the access router, where the data carries the routing cost information.

A data cache system provided in an embodiment of the disclosure includes: at least one access router covered by at least one routing area, at least one intermediate router, at least one data cache node, and at least one gateway node, where: a P2P network is set up between the gateway nodes; and the information registered on the P2P network includes the information about routing from the access router, the intermediate router and the data cache node to the gateway node in the home routing area, and includes the data information stored on the access router, the intermediate router, the data cache node, and the gateway node.

The access router is adapted to: send a received data request to the gateway node; receive location information from the gateway node, where the location information identifies the data cache node obtained according to the data request, and obtain the information about the cost of routing from the access router to the data cache node according to the location information; and send a data obtaining request to the data cache node, where the data obtaining request carries the routing cost information.

The gateway node is adapted to: search the P2P network for information about the location of the data cache node which stores the data corresponding to the data request, and send the location information to the access router.

The data cache node is adapted to: receive the data obtaining request from the access router, and send the data corresponding to the data obtaining request to the access router, where the data carries the routing cost information.

The intermediate router is adapted to: receive the data sent by the data cache node to the access router, determine information about the sending priority of the data according to the routing cost information carried in the data, and send the data according to the sending priority information.

The method for sending a message, the access router, and the data cache system provided herein sort the data according to the sending priority based on the information about the cost of routing from the access router to the data cache node, thus utilizing the radio bandwidth efficiently and improving the network throughput.

### BRIEF DESCRIPTION OF THE DRAWINGS

FIG. 1 is a schematic diagram of a P2P cache system in the conventional art;

FIG. 2 shows a structure of a radio mesh network in an embodiment of the disclosure;

FIG. 3 shows a structure of a data cache system in an embodiment of the disclosure;

FIG. 4 shows a process of a method for sending a message in the first embodiment of the disclosure;

FIG. 5 shows a process of a method for sending a message in the second embodiment of the disclosure;

FIG. 6 shows a process of a method for sending data in the first embodiment of the disclosure;

FIG. 7 shows a process of a method for sending data in the second embodiment of the disclosure;

FIG. 8 shows a process of a method for obtaining a data location in the first embodiment of the disclosure;

FIG. 9 shows a process of a method for obtaining a data location in the second embodiment of the disclosure;

FIG. 10 shows calculation of a fair bandwidth according to the method for obtaining a data location in the second embodiment of the disclosure;

FIG. 11 shows a process of a method for sending data in the third embodiment of the disclosure;

FIG. 12 shows a process of a method for sending data in the fourth embodiment of the disclosure;

FIG. 13 shows a structure of an access router in the first embodiment of the disclosure;

FIG. 14 shows a structure of an access router in the second embodiment of the disclosure;

FIG. 15 shows a structure of a data cache node in the first embodiment of the disclosure;

FIG. 16 shows a structure of a data cache node in the second embodiment of the disclosure;

FIG. 17 shows a structure of a gateway node in the first embodiment of the disclosure;

FIG. 18 shows a structure of a gateway node in the second embodiment of the disclosure;

FIG. 19 shows a structure of an intermediate router in the first embodiment of the disclosure; and

FIG. 20 shows a structure of an intermediate router in the second embodiment of the disclosure.

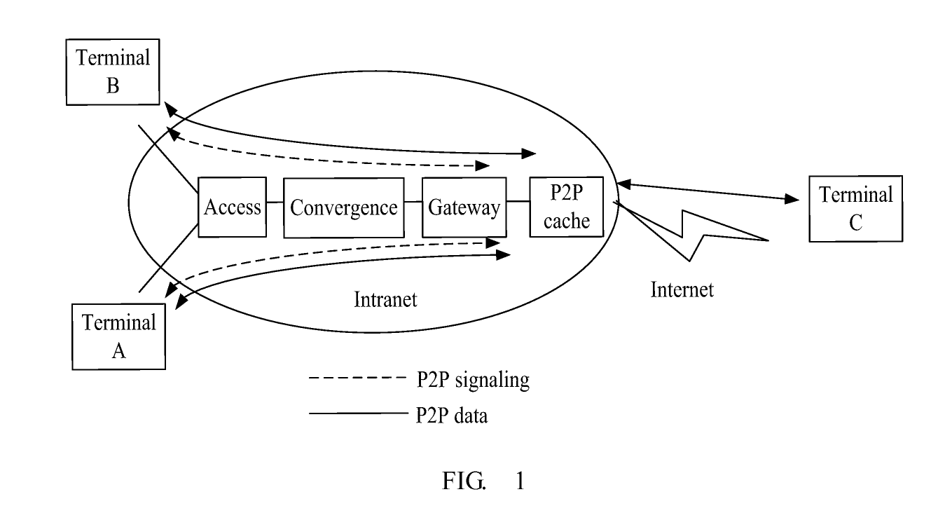

### DETAILED DESCRIPTION OF THE INVENTION

The structure of a radio mesh network may be a planar structure, a hierarchical structure, or a hybrid structure. All nodes in the planar structure are in a P2P structure. Because the radio coverage of a node is limited, two user terminals which are unable to communicate with each other directly may perform data communication by means of the packet forwarding function of other terminals without extra infrastructure. The hierarchical structure includes an upper layer and a lower layer. The client node in the lower layer may access the upper-layer mesh network through a mesh router to implement interconnection and communication between network nodes. The mesh router is capable of route selection and relay, and provides the client node with a radio link connected to the gateway node. Compared with the hierarchical structure, the hybrid structure adds a mesh device capable of forwarding and routing, and therefore, wireless interconnection is enabled between user nodes.

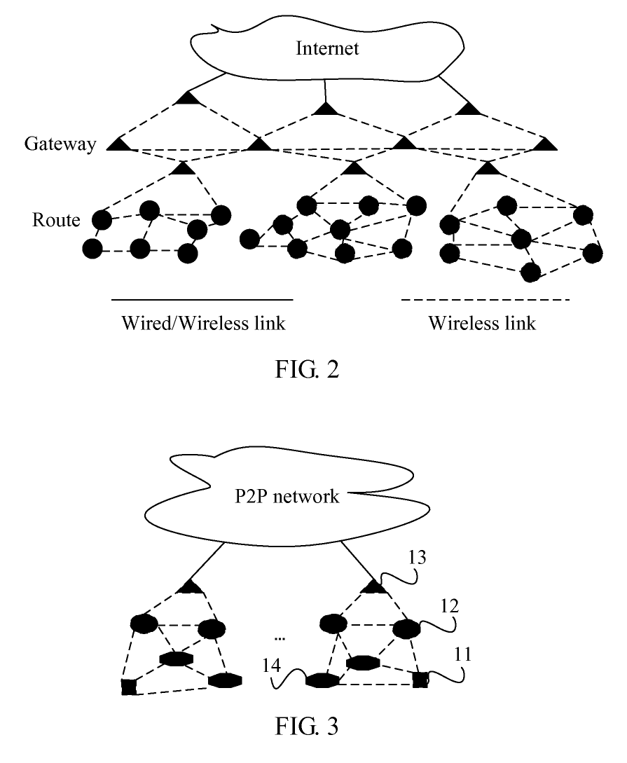

FIG. 2 shows a structure of a radio mesh network in an embodiment of the disclosure. A radio mesh network is composed of a mesh client terminal and a mesh router. The mesh router has the functions of a gateway, relay or router. The node that has the functions of a gateway is connected to the Internet through a wireless or wired network, and serves as an access gateway of other radio mesh nodes. Due to limited radio bandwidths and gateway nodes, a data congestion bottleneck tends to occur at the access gateway node. Because the users in the same location area access similar Internet contents, the forwarded contents may be cached on the router to lessen the load of the gateway node and reduce the probability of data congestion.

Described below is an embodiment of a data cache system under the disclosure.

FIG. 3 shows a structure of a data cache system in an embodiment of the disclosure. The data cache system may include: an access router 11, a data cache node 12, a gateway node 13, and an intermediate router 14. In practice, a data routing system may include at least one access router 11, at least one data cache node 12, at least one gateway node 13, and at least one intermediate router 14. The gateway node 13 sends a routing broadcast message which carries the identifier of the gateway node. The access router 11, the data cache node 12, and the intermediate router 14 forwards only the routing broadcast message which involves the minimum cost of routing from the gateway node 13 to such nodes among all the received routing broadcast messages, and attach themselves to the gateway node 13 which sends the routing broadcast message according to the identifier carried in the routing broadcast message. In this way, a cluster which uses the gateway node 13 as a cluster center is generated, and this cluster is a routing area. A P2P network is set up between gateway nodes 13. The P2P network may be based on a distributed Hash table. Because this network is set up between gateway nodes 13 and does not include the gateway node 13, the access router 11, the data cache node 12, or the intermediate router 14, maintenance of such nodes is avoided and the bandwidth is saved, and fewer channel resources are consumed. The access router 11, the data cache node 12, and the intermediate router 14 register the information about routing from themselves to the gateway node 13 in the home routing area and the data information stored in the access router 11, the data cache node 12, the gateway node 13, and the intermediate router 14 into the P2P network. Therefore, it is easy for the gateway node 13 to search for information. If existing data is deleted from the access router 11, the data cache node 12, or the intermediate router 14, such nodes send deregistration information of the data to the P2P network; and, if new data is added to the access router 11 or the data cache node 12, such nodes send registration information of the data to the P2P network. The access router 11 sends the received data request to the gateway node 13. The gateway node 13 searches the P2P network for the information about the location of the data cache node 12 which stores the data corresponding to the data request according to the received data request, and sends the location information to the access router 11. The location information identifies the data cache node obtained according to the data request. The access router 11 receives the location information, and obtains the information about the cost of routing from the access router 11 to the data cache node 12 according to the location information, and then sends a data obtaining request to the data cache node 12. The data obtaining request carries the routing cost information. The data cache node 12 receives the data obtaining request, and sends the data corresponding to the data obtaining request to the access router 11, where the data carries the routing cost information. The intermediate router 14 receives the data sent by the data cache node 12 to the access router 11, determines the information about the sending priority of the data according to the routing cost information carried in the data, and sends the data according to the sending priority information.

In this embodiment, the location information of the data cache node 12 is obtained by the gateway node 13 from the P2P network set up between the gateway nodes 13. Therefore, the access router does not need to send a routing broadcast message to obtain the location information, and fewer channel resources of the network are consumed. Moreover, the data information cached by all nodes is registered on the P2P network. Therefore, the data request scope of the data request information sent by the terminal is large. The intermediate router 14 determines the sending priority of the data according to the information about the cost of routing from the data cache node 12 to the access router 11, and forwards the data according to the sending priority information. The mutual interference of channels between nodes and the load of each node are measured through the routing cost information. Therefore, the radio bandwidth is utilized efficiently, and the data throughput of the user is maximized.

Described below is the first embodiment of a method for sending a message under the disclosure.

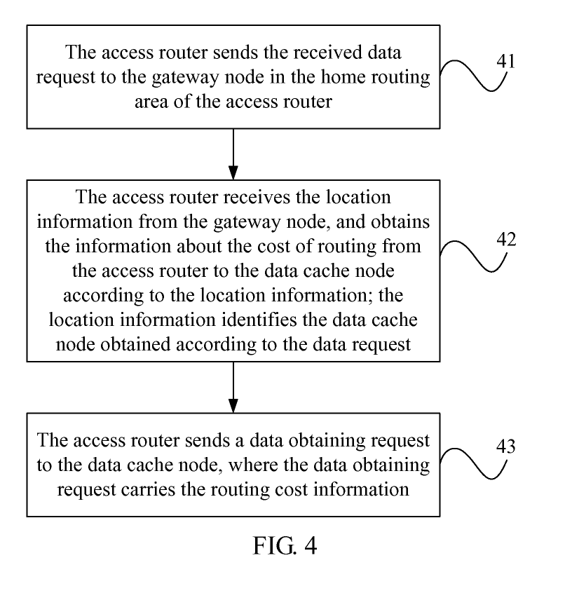

FIG. 4 shows a process of a method for sending a message in the first embodiment of the disclosure. The method may include the following steps:

Step 41: The access router sends the received data request to the gateway node in the home routing area of the access router.

In the radio mesh network, each gateway node sends a routing broadcast message. Each router forwards only the routing broadcast message which involves the minimum cost of routing from each gateway node to the router among all the received routing broadcast messages, and attaches the router itself to the gateway node which sends the routing broadcast message of the minimum cost. In this way, a cluster which uses the gateway node as a cluster center is generated, and this cluster is called a routing area. When the radio terminal requests data, the radio terminal sends a data request to a router, and this router is called an access router. If the data is cached in the access router, the data is sent to the terminal directly; otherwise, the data request is forwarded to the gateway node in the home routing area of the access router. The data request carries keywords of the data.

Step 42: The access router receives the location information from the gateway node, and obtains the information about the cost of routing from the access router to the data cache node according to the location information. The location information identifies the data cache node obtained according to the data request.

If the gateway node fails to find the information about the location of the data cache node which caches the data corresponding to the data request in the P2P network, the gateway node obtains the data from the Internet directly and sends the data to the access router. The access router sends the data to the terminal. If the gateway node obtains the information about the location of the data cache node which caches the data according to the keywords of the data request, the gateway node sends the location information to the access router, and then the access router obtains the information about the cost of routing from the access router to the data cache node according to the location information.

Step 43: The access router sends a data obtaining request to the data cache node, where the data obtaining request carries the routing cost information.

In this embodiment, the location information of the data cache node is sent by the gateway node, and the access router does not need to send a routing broadcast message to obtain the location information. Therefore, the channel resources of the network are saved; the radio bandwidth is utilized efficiently; and the data throughput of the user is maximized.

Described below is the second embodiment of a method for sending a message under the disclosure.

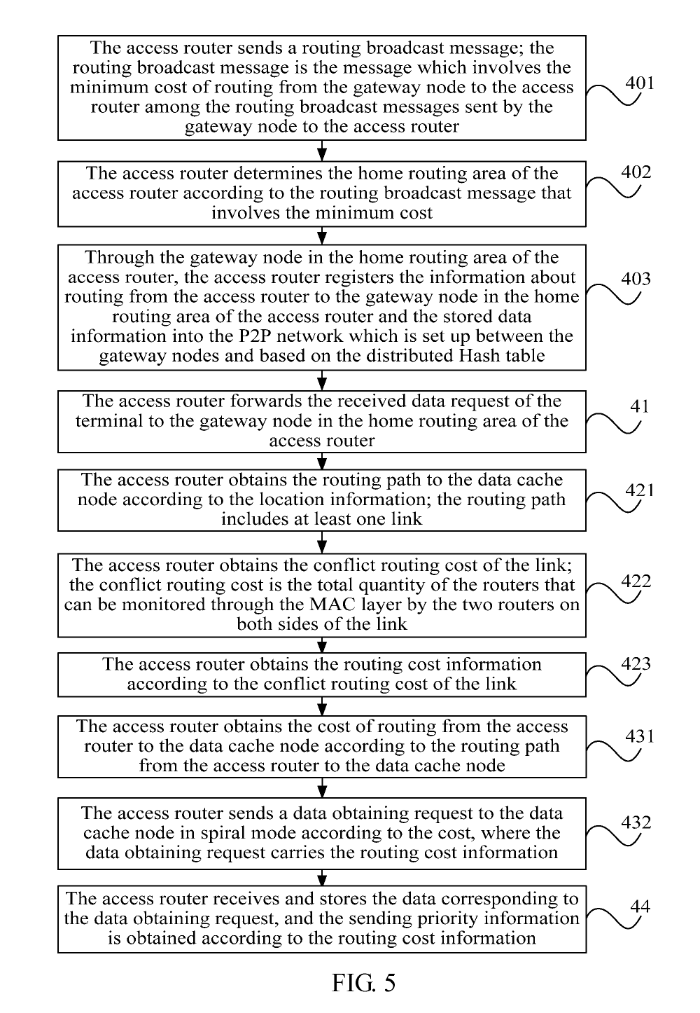

FIG. 5 shows a process of a method for sending a message in the second embodiment of the disclosure. On the basis of the technical solution in FIG. 4, step 42 may include the following steps:

Step 421: The access router obtains the routing path to the data cache node according to the location information. The routing path includes at least one link.

Specifically, according to the location information of the data cache node, the access router judges whether the data cache node is located in the home routing area of the access router, or located in the home routing area of the gateway node adjacent to the gateway node in the home routing area of the access router. If the data cache node is located in the home routing area of the access router, the access router sends a routing broadcast message to obtain the routing path to the data cache node. The routing broadcast message is forwarded by other routers in the home routing area of the access router and arrives at the data cache node. The data cache node selects a path of the minimum cost as the routing path to the access router. If the data cache node is located in the home routing area of the gateway node adjacent to the gateway node in the home routing area of the access router, the access router obtains the default routing path or sends a routing broadcast message to obtain the routing path to the data cache node. The default routing path is from the access router to the gateway node in the home routing area of the access router, and to the gateway node adjacent to that gateway node, and finally to the data cache node.

Step 422: The access router obtains the conflict routing cost of the link. The conflict routing cost is the total quantity of the routers that can be monitored through the MAC layer by the two routers on both sides of the link.

Specifically, it is assumed that in the radio network, all radio routers have the same transmit power and the same antenna height. According to the radio interference protocol model, all routers have the same interference scope. Therefore, when the scope is constant, more routers in the area lead to higher mutual interference. Supposing the routers are distributed evenly, considering that the data scope that can be monitored correctly by the router is in proportion to the interference scope of the transmitted signal, the quantity of the nodes that can be monitored by the router may represent the extent of conflict that possibly occurs when this node transmits a signal; and the total quantity of the routers that can be monitored by two adjacent nodes may represent the extent of conflict possibly caused by data transmission on this link, namely, the conflict routing cost of this link.

Step 423: According to the conflict routing cost of the link, the access router obtains the routing cost information. Specifically, the conflict routing costs of all links are added up to obtain the routing cost information for measuring the extent of conflict that possibly occurs when the data is transmitted along the routing path.

On the basis of the technical solution in FIG. 4, the following steps may occur before step 41:

Step 401: The access router sends a routing broadcast message. The routing broadcast message involves the minimum cost of routing from the gateway node to the access router among the routing broadcast messages sent by the gateway node to the access router.

If each gateway node is regarded as a lowest point of terrain, each router disseminates the routing broadcast message to other nodes according to the watershed algorithm. The routing broadcast message carries the identifier of each gateway node. That is, each router forwards only the routing broadcast message which involves the minimum cost of routing from each gateway node to other routers.

Step 402: The access router determines the home routing area of the access router according to the routing broadcast message that involves the minimum cost.

Each router attaches itself to the gateway node which sends the routing broadcast message according to the identifier carried in the routing broadcast message that involves the minimum cost. In this way, a cluster which uses the gateway node as a cluster center is generated between routers, and this cluster is a routing area.

Step 403: Through the gateway node in the home routing area of the access router, the access router registers the information about routing from the access router to the gateway node in the home routing area of the access router and the stored data information into the P2P network which is set up between the gateway nodes and based on the distributed Hash table.

Because the P2P network is set up between the gateway nodes and does not include the routers, it is not necessary to maintain the routers, and the bandwidth resources are saved. The information about routing from each router to the gateway node and the cached data information are registered into the P2P network, thus making it easy to search for information. If existing data is deleted from each router according to the local cache policy, the router sends deregistration information of the data to the P2P network; and, if new data for caching is added to each router, the router sends registration information of the data to the P2P network.

If the gateway node obtains location information of multiple data cache nodes, two circumstances may occur: First, there are multiple data cache nodes that store the data; secondly, the data requested by the terminal is stored into multiple data cache nodes in segments, and each data cache node stores a data segment. For the first circumstance, the access router sends the data obtaining request only to the data cache node which involves the minimum routing cost according to the information about the cost of the routing path to each data cache node; for the second circumstance, the following steps are performed:

Step 431: The access router obtains the cost of routing from the access router to the data cache node according to the routing path from the access router to the data cache node.

Step 432: The access router sends a data obtaining request to the data cache node in spiral mode according to the cost, where the data obtaining request carries the routing cost information.

The following steps may occur after the data obtaining request is sent to the data cache node:

Step 44: The access router receives and stores the data corresponding to the data obtaining request, and the sending priority information is obtained according to the routing cost information.

A greater routing cost of data indicates more serious conflict that may occur when the data is transmitted on each link along the routing path from the data cache node to the access router. Therefore, the data with lower routing costs is forwarded first. In this way, the probability of sending the data successfully is increased, and the channel resources of the network are utilized efficiently.

In this embodiment, the access router receives the information about the location of the data cache node from the gateway node in the home routing area of the access router, and does not need to send a routing broadcast message to obtain the information about the location of the data cache node, thus saving channel resources. The data is arranged according to the sending priority based on the routing cost information. The mutual interference of channels between nodes is measured according to the quantity of the routers that can be monitored by the two routers on both sides of the link. When conflict or congestion occurs on the channel, the data may be obtained effectively as far as possible. Therefore, the channel resources are utilized efficiently, and the network throughput is improved.

Described below is the first embodiment of a method for sending data under the disclosure.

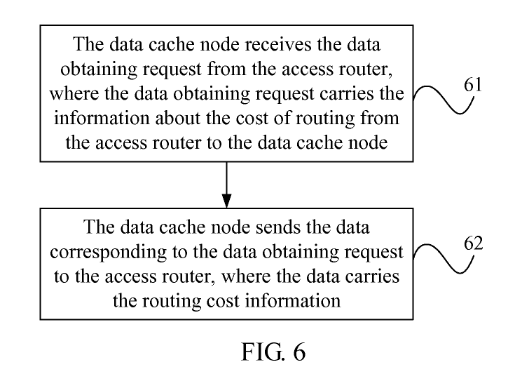

FIG. 6 shows a process of a method for sending data in the first embodiment of the disclosure. The method may include the following steps:

Step 61: The data cache node receives the data obtaining request from the access router, where the data obtaining request carries the information about the cost of routing from the access router to the data cache node.

The routing information indicates the extent of conflict that may occur in the process of routing the data.

Step 62: The data cache node sends the data corresponding to the data obtaining request to the access router, where the data carries the routing cost information.

In this embodiment, the data cache node sends the data corresponding to the data obtaining request to the access router, and the data carries the information about the cost of routing from the access router to the data cache node. Through the routing cost information, the mutual interference of channels between nodes and the load of each node are measured. Therefore, the channel resources are utilized efficiently, and the network throughput is improved.

Described below is the second embodiment of a method for sending data under the disclosure.

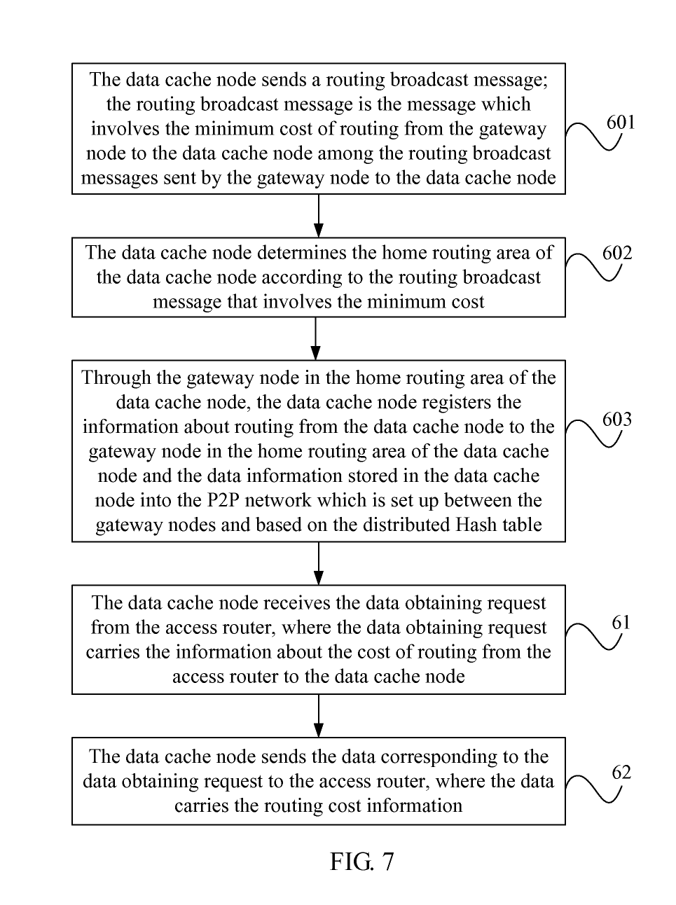

FIG. 7 shows a process of a method for sending data in the second embodiment of the disclosure. On the basis of the technical solution in FIG. 6, the routing area may be defined and the P2P network may be set up before step 61, as described below:

Step 601: The data cache node sends a routing broadcast message. The routing broadcast message involves the minimum cost of routing from the gateway node to the data cache node among the routing broadcast messages sent by the gateway node to the data cache node.

If each gateway node is regarded as a lowest point of terrain, each router disseminates the routing broadcast message to other nodes according to the watershed algorithm. The routing broadcast message carries the identifier of each gateway node. That is, each router forwards only the routing broadcast message which involves the minimum cost of routing from each gateway node to other routers.

Step 602: The data cache node determines the home routing area of the data cache node according to the routing broadcast message that involves the minimum cost.

Each router attaches itself to the gateway node which sends the routing broadcast message according to the identifier carried in the routing broadcast message that involves the minimum cost. In this way, a cluster which uses the gateway node as a cluster center is generated between routers, and this cluster is a routing area.

Step 603: Through the gateway node in the home routing area of the data cache node, the data cache node registers the information about routing from the data cache node to the gateway node in the home routing area of the data cache node and the data information stored in the data cache node into the P2P network which is set up between the gateway nodes and based on the distributed Hash table.

Because the P2P network is set up between the gateway nodes and does not include the routers, it is not necessary to maintain the routers, and the bandwidth resources are saved. The information about routing from each router to the gateway node and the cached data information are registered into the P2P network, thus making it easy for the gateway node to search for information.

In this embodiment, the data cache node sends the data corresponding to the data obtaining request to the access router, and the data carries the information about the cost of routing from the access router to the data cache node. Through the routing cost information, the mutual interference of channels between nodes is measured. Therefore, the radio bandwidth is utilized efficiently, and the network throughput is improved.

Described below is the first embodiment of a method for obtaining a data location under the disclosure.

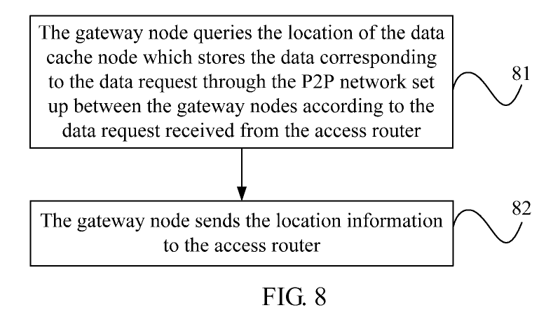

FIG. 8 shows a process of a method for obtaining a data location in the first embodiment of the disclosure. The method may include the following steps:

Step 81: The gateway node queries the location of the data cache node which stores the data corresponding to the data request through the P2P network set up between the gateway nodes according to the data request received from the access router.

The P2P network may be based on the distributed Hash table. The routing information of all routers in the radio mesh network and the cached data information are registered in this P2P network. According to the keyword carried in the data request, the gateway node may search the P2P network for the location of the data cache node which stores the data corresponding to the keyword. Therefore, the data request scope is expanded effectively. Moreover, the P2P network is set up between gateway nodes, and does not include the routers. Therefore, no router needs to be maintained, and the network resources are saved.

Step 82: The gateway node sends the location information to the access router.

In this embodiment, the location information of the data cache node is searched out in the P2P network set up between the gateway nodes after a data request of the terminal node is received. The data request is forwarded by the access router in the home routing area of the gateway node. Moreover, the location information is sent to the access router, and the access router does not need to send a routing broadcast message to obtain the location information of the data cache node. Therefore, fewer channel resources of the radio mesh network are consumed; the radio bandwidth is utilized efficiently; and the network throughput is improved.

Described below is the second embodiment of a method for obtaining a data location under the disclosure.

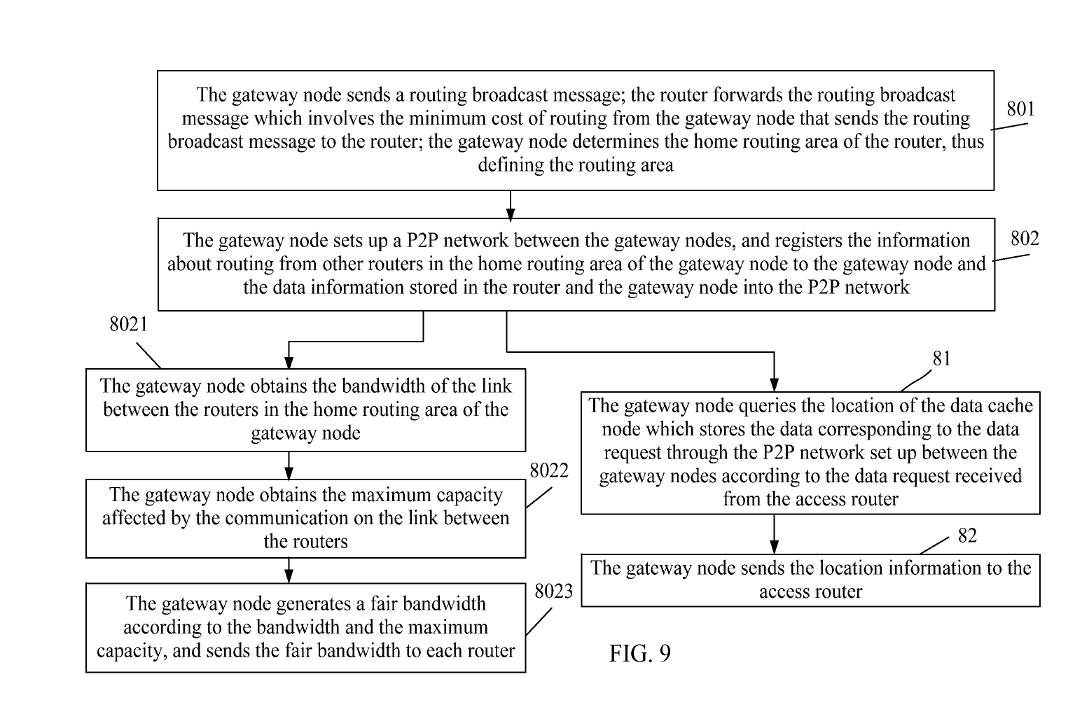

FIG. 9 shows a process of a method for obtaining a data location in the second embodiment of the disclosure. On the basis of the technical solution shown in FIG. 8, the routing area may be defined and the P2P network may be set up before step 81, as described below:

Step 801: The gateway node sends a routing broadcast message. The router forwards the routing broadcast message which involves the minimum cost of routing from the gateway node that sends the routing broadcast message to the router. The gateway node determines the home routing area of the router, thus defining the routing area.

The gateway node sends the routing broadcast message. Each router calculates the minimum cost of routing to the gateway node based on the shortest path algorithm (Bellman-Food) according to the routing broadcast message.

Step 802: The gateway node sets up a P2P network between the gateway nodes, and registers the information about routing from other routers in the home routing area of the gateway node to the gateway node and the data information stored in the router and the gateway node into the P2P network.

In step 802, the P2P network is set up between the gateway nodes, and does not include the router in the home routing area of the gateway node. Therefore, it is convenient for the gateway node to search the P2P network for the required data resources. The P2P network does not need to maintain the nodes, thus saving maintenance resources massively.

Supposing a router pair affects only the adjacent router in the transmission process, the fair bandwidth of each router may be obtained according to the quantity of the routers. After step 802, the fair bandwidth may be obtained through the following steps:

Step 8021: The gateway node obtains the bandwidth of the link between the routers in the home routing area of the gateway node.

Step 8022: The gateway node obtains the maximum capacity affected by the communication on the link between the routers.

Step 8023: The gateway node generates a fair bandwidth through the following formula according to the bandwidth and the maximum capacity, and sends the fair bandwidth to each router: Gₘₐₓ=B/Cₘₐₓ, where: Gₘₐₓ represents the fair bandwidth; B represents the bandwidth; and Cₘₐₓ represents the maximum capacity.

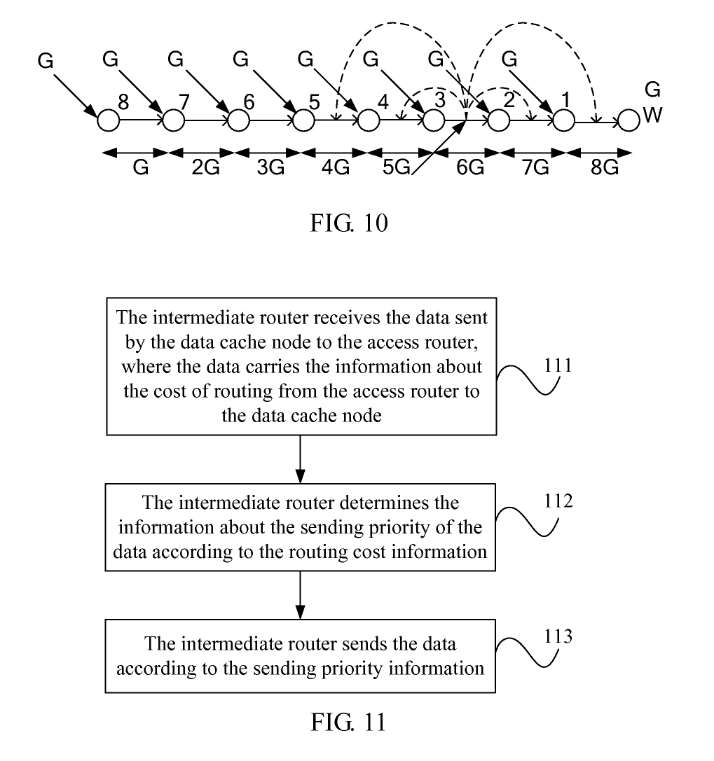

FIG. 10 shows calculation of the fair bandwidth in the method for obtaining a data location in the second embodiment of the disclosure. The capacity affected by the communication on the link between node 2 and node 3 is the largest, and covers node 1 and node 4. Therefore, link 2-3 conflicts with link 1-GW, link 1-2, link 3-4, and link 4-5. The maximum capacity affected by the communication on link 2-3 is 4G+5G+6G+7G+8G=30G. Supposing the bandwidth of the link between the nodes is B, the fair bandwidth available to each router in the routing area is G max=B/30.

Steps 8021-8023 may occur before, during or after steps 81-82.

In this embodiment, the routing information and the data information of the router in the home routing area of the gateway node are registered into the P2P network which is set up between gateway nodes and based on the distributed Hash table. Therefore, the location information of the data cache node may be searched out in the P2P network, and no routing broadcast message needs to be sent to search for the location information of the data cache node. The channel resources of the radio mesh network are saved. The data cache node may be located in any routing area. Therefore, the data request scope is expanded; the radio bandwidth is utilized efficiently; and the network throughput is improved.

Described below is the third embodiment of a method for sending data under the disclosure.

FIG. 11 shows a process of a method for sending data in the third embodiment of the disclosure. The method may include the following steps:

Step 111: The intermediate router receives the data sent by the data cache node to the access router, where the data carries the information about the cost of routing from the access router to the data cache node.

Step 112: The intermediate router determines the information about the sending priority of the data according to the routing cost information.

Due to characteristics of the radio channel transmission, when a router pair transmits data, the communication of other routers within the interference scope of the router pair is also suppressed. If the transmission distance between the router pairs is longer, the interference scope is larger, and the probability of conflicting with other routers is higher. Therefore, the route forwarding policy based on the minimum cost principle in the fixed network is not suitable for radio networks. The routing of the radio network needs to allow for the conflict routing cost caused by the routing data in the routing process.

Step 113: The intermediate router sends the data according to the sending priority information.

The data with a higher sending priority is forwarded first, thus improving reliability of data transmission.

In this embodiment, the intermediate router determines the sending priority of the data according to the information about the cost of routing from the data cache node to the access router, and sends the data according to the sending priority. Through the routing cost information, the intermediate router measures the mutual interference of channels between nodes, thus improving reliability of channel transmission and utilizing the radio bandwidth efficiently.

Described below is the fourth embodiment of a method for sending data under the disclosure.

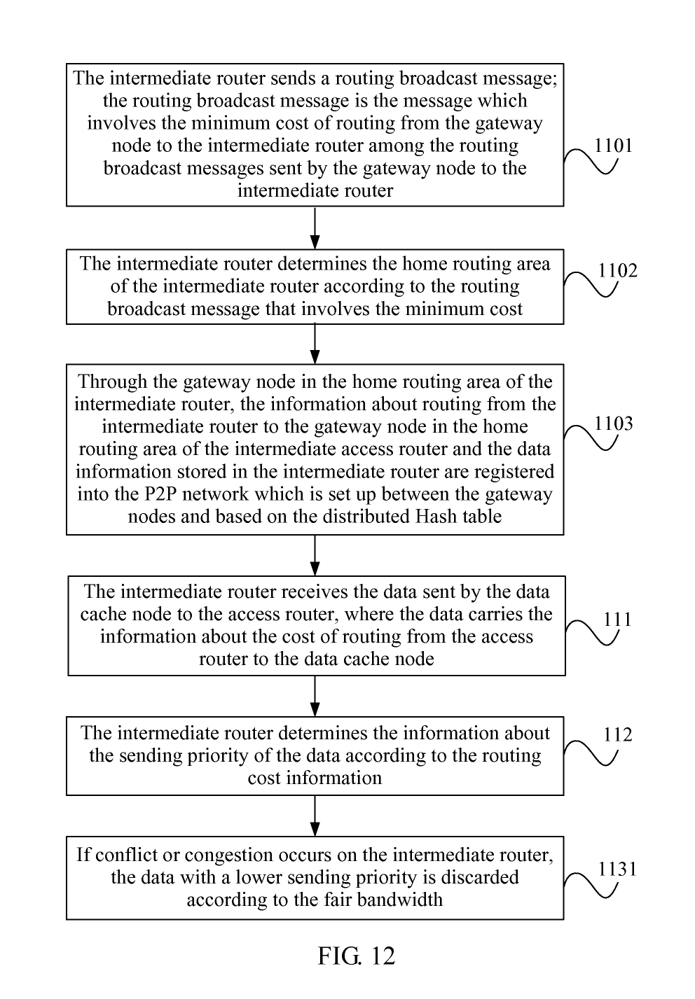

FIG. 12 shows a process of a method for sending data in the fourth embodiment of the disclosure. On the basis of the technical solution shown in FIG. 11, step 113 includes the following steps:

Step 1131: If conflict or congestion occurs on the intermediate router, the data with a lower sending priority is discarded according to the fair bandwidth.

Supposing each router in the same routing area transmits data to the same gateway node equally, namely, supposing each router has the same bandwidth from the gateway node to the Internet (this bandwidth is called “fair bandwidth”), the data that goes beyond the fair bandwidth is discarded when data conflict or congestion occurs on the data cache node. Moreover, the sending priority of such data is lower. Therefore, the data with a higher sending priority is transmitted more reliably, and the radio bandwidth is utilized efficiently.

On the basis of the technical solution shown in FIG. 11, the following steps may occur before step 111:

Step 1101: The intermediate router sends a routing broadcast message. The routing broadcast message involves the minimum cost of routing from the gateway node to the intermediate router among the routing broadcast messages sent by the gateway node to the intermediate router.

Specifically, the cost may be the quantity of hops from the gateway node to the intermediate router, or other radio routing cost measures such as Expected Transmission Count (ETX) and Expected Transmission Time (ETT).

Step 1102: The intermediate router determines the home routing area of the intermediate router according to the routing broadcast message that involves the minimum cost.

The intermediate router attaches itself to the gateway node which sends the routing broadcast message involving the minimum cost. In this way, a cluster which uses the gateway node as a cluster center is generated, and this cluster is called a routing area.

Step 1103: Through the gateway node in the home routing area of the intermediate router, the information about routing from the intermediate router to the gateway node in the home routing area of the intermediate access router and the data information stored in the intermediate router are registered into the P2P network which is set up between the gateway nodes and based on the distributed Hash table.

The P2P network does not include the intermediate routers. Therefore, no bandwidth is required for maintaining the intermediate routers. The routing information and the data information of the intermediate routers are registered into the P2P network to facilitate searching by the gateway node.

On the basis of the technical solution shown in FIG. 11, the following steps may occur after step 113:

Step 114: The intermediate router stores the data sent by the data cache node to the access router.

The local cache of the intermediate router does not store the data sent by the data cache node to the access router. With the data being stored into the local cache, the hit rate of the local cache is increased.

In this embodiment, the intermediate router sorts the data to be forwarded according to the sending priority based on the routing cost information, and the data with a higher sending priority is forwarded first. When conflict or congestion occurs on the intermediate router, the data which goes beyond the fair bandwidth and is of a lower sending priority is discarded. The mutual interference of the channels between the routers is measured through the routing cost information, thus improving the reliability of data transmission and improving the utilization of the radio bandwidth.

Described below is the first embodiment of an access router under the disclosure.

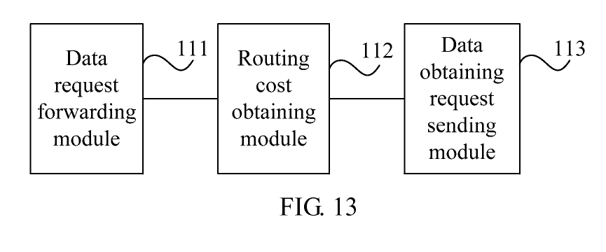

FIG. 13 shows a structure of an access router in the first embodiment of the disclosure. The access router includes: a data request forwarding module 111, a routing cost obtaining module 112, and a data obtaining request sending module 113. First, the data request forwarding module 111 sends the data request received by the access router to the gateway node in the home routing area of the access router. The routing cost obtaining module 112 receives the location information from the gateway node, where the location information identifies the data cache node obtained according to the data request, and obtains the information about the cost of routing from the access router to the data cache node according to the location information. Finally, the data obtaining request sending module 113 sends the data obtaining request to the data cache node. The data obtaining request carries the routing cost information.

In this embodiment, the location information obtained by the routing cost obtaining module 111 is sent by the gateway node, and does not need to be obtained through the routing broadcast message, thus saving the channel resources of the network. The routing cost information fully allows for the mutual interference of channels, and therefore, the radio bandwidth is utilized efficiently and the data throughput of the user is maximized.

Described below is the second embodiment of an access router under the disclosure.

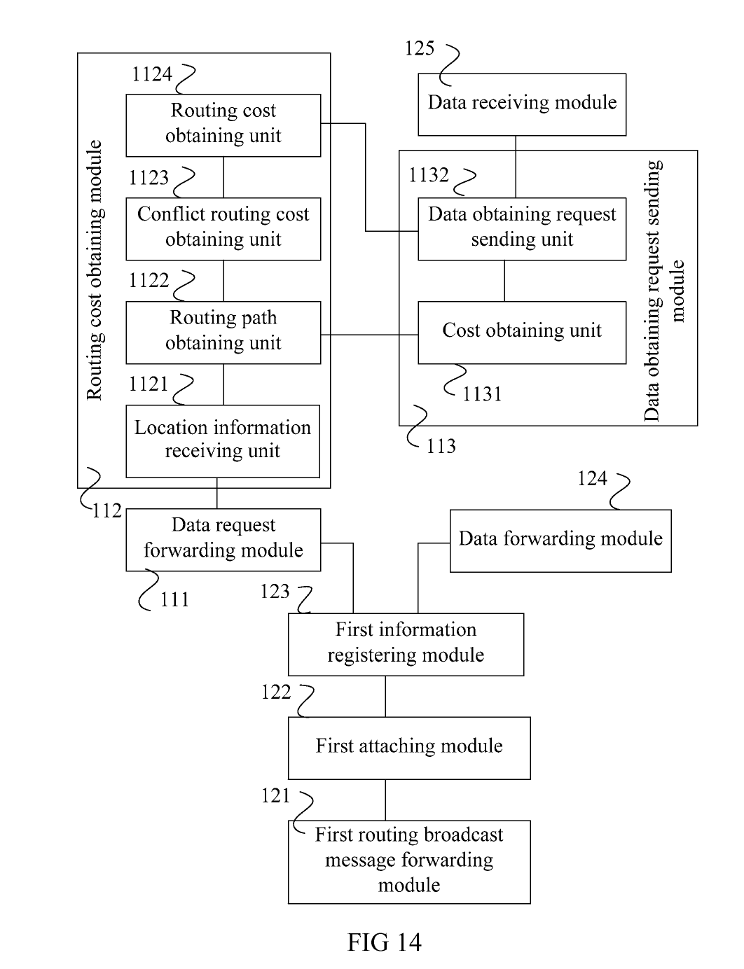

FIG. 14 shows a structure of an access router in the second embodiment of the disclosure. The access router may include: a first routing broadcast message forwarding module 121, a first attaching module 122, a first information registering module 123, a data forwarding module 124, a data request forwarding module 111, a routing cost obtaining module 112, a data obtaining request sending module 113, and a data receiving module 125. Specifically, the routing cost obtaining module 112 may include: a location information receiving unit 1121, a routing path obtaining unit 1122, a conflict routing cost obtaining unit 1123, and a routing cost obtaining unit 1124. The data obtaining request sending module 113 may include: a cost obtaining unit 1131, and a data obtaining request sending unit 1132. The first routing broadcast message forwarding module 121 sends a routing broadcast message. This routing broadcast message involves the minimum cost of routing from the gateway node to the access router among the routing broadcast messages sent from the gateway node to the access router. Specifically, the routing broadcast message carries the identifier of each gateway node. The first attaching module 122 determines the home routing area of the access router according to the routing broadcast message that involves the minimum cost. Specifically, the first attaching module 122 attaches the access router to the gateway node which sends the routing broadcast message according to the identifier. In this way, a cluster which uses the gateway node as a cluster center is generated, and this cluster is called a routing area. Through the gateway node in the home routing area of the access router, the first information registering module 123 registers the information about routing from the access router to the gateway node in the home routing area of the access router and the data information stored in the access router into the P2P network which is set up between the gateway nodes and based on the distributed Hash table, thus facilitating the gateway node to search the P2P network for information. After the routing area is defined and the P2P network is set up, the location information receiving unit 1121 receives the location information from the gateway node. The routing path obtaining unit 1122 obtains the routing path from the access router to the data cache node according to the location information. The routing path includes at least one link. The conflict routing cost obtaining unit 1123 obtains the conflict routing cost of the link. The conflict routing cost is the total quantity of the routers that can be monitored through the MAC layer by the two routers on both sides of the link. The routing cost obtaining unit 1124 obtains the routing cost information according to the conflict routing cost of the link. Specifically, the conflict routing costs of the link are added up to obtain the routing cost information. The cost obtaining unit 1131 obtains the cost of routing from the access router to the data cache node according to the routing path from the access router to the data cache node. The data obtaining request sending unit 1132 sends a data obtaining request to the data cache node in spiral mode according to the cost. The data receiving module 125 receives and stores the data corresponding to the data obtaining request. Besides, after the access router receives the data request from the terminal, if any data corresponding to the data request is stored in the access router, the data forwarding module 124 sends the data to the terminal directly.

In this embodiment, the location information receiving unit 1121 receives the location information from the gateway node, and it is not necessary for the access router to send the routing broadcast message to obtain the location information, thus saving channel resources. The conflict routing cost obtaining unit 1123 obtains the conflict routing cost. The conflict routing cost is the total quantity of the routers that can be monitored through the MAC layer by the two routers on both sides of each link on the routing path from the access router to the data cache node. The routing cost obtaining unit 1124 obtains the information about the cost of routing from the access router to the data cache node according to the conflict routing cost. The mutual interference of channels is fully considered; the channel resources are utilized efficiently; and the network throughput is improved.

Described below is the first embodiment of a data cache node under the disclosure.

FIG. 15 shows a structure of a data cache node in the first embodiment of the disclosure. The data cache node may include a data obtaining request receiving module 131 and a data sending module 133. The data obtaining request receiving module 131 is adapted to: receive the data obtaining request from the access router, where the data obtaining request carries the information about the cost of routing from the access router to the data cache node. The data sending module 133 is adapted to send the data to the access router, where the data carries the routing cost information.

In this embodiment, the data obtaining request receiving module 131 receives the data obtaining request from the access router, where the data obtaining request carries the information about the cost of routing from the access router to the data cache node; and the data sending module 133 sends data to the access router, and measures the mutual interference of channels between the routers through the routing cost information, thus utilizing the channel resources efficiently and improving the network throughput.

Described below is the second embodiment of a data cache node under the disclosure.

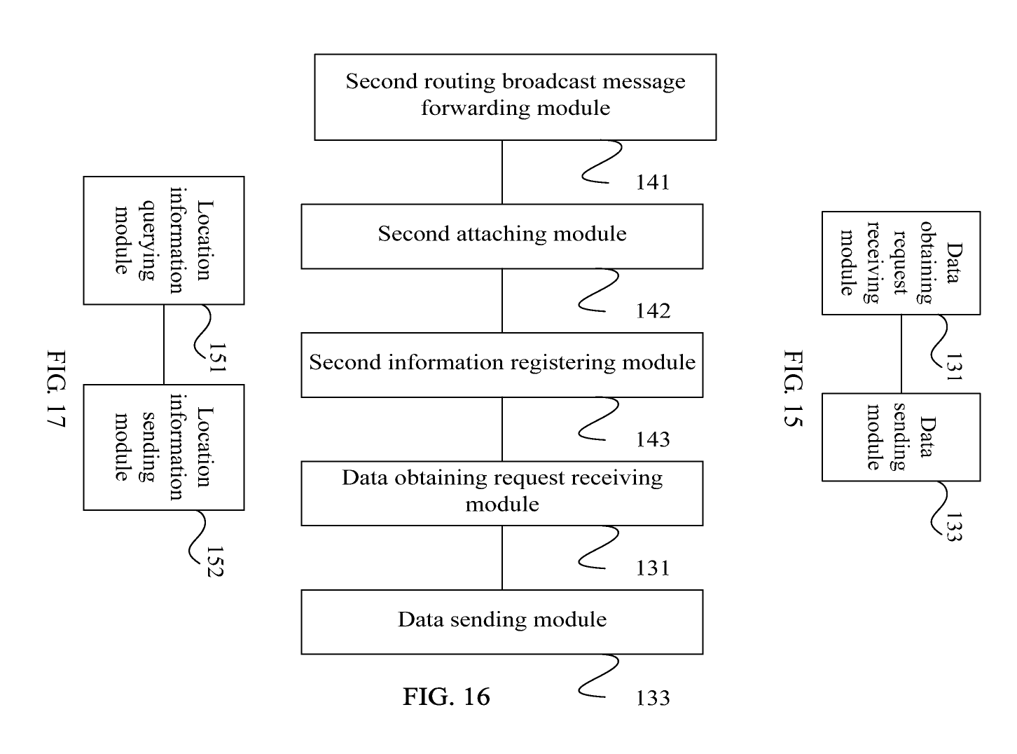

FIG. 16 shows a structure of a data cache node in the second embodiment of the disclosure. The data cache node includes: a second routing broadcast message forwarding module 141, a second attaching module 142, a second information registering module 143, a data request receiving module 131, and a data sending module 133. The second routing broadcast message forwarding module 141 sends a routing broadcast message. The routing broadcast message involves the minimum cost of routing from the gateway node to the data cache node among the routing broadcast messages sent by the gateway node to the data cache node. Specifically, the routing broadcast message carries the identifier of each gateway node. The second attaching module 142 determines the home routing area of the data cache node according to the routing broadcast message that involves the minimum cost. Specifically, the second attaching module 142 attaches the data cache node to the gateway node which sends the routing broadcast message of the minimum cost according to the identifier. Through the gateway node in the home routing area of the data cache node, the second information registering module 143 registers the information about routing from the data cache node to the gateway node in the home routing area of the data cache node and the data information stored in the data cache node into the P2P network which is set up between the gateway nodes and based on the distributed Hash table. After the routing area is determined and the P2P network is set up, the data obtaining request receiving module 131 receives the data obtaining request from the access router, where the data obtaining request carries the information about the cost of routing from the access router to the data cache node; and the data sending module 133 sends data to the access router, where the data carries the routing cost information.

In this embodiment, the second information registering module 143 registers the information, and the data sending module 133 sends the data corresponding to the data obtaining request to the access router, where the data carries the routing cost information. Through the routing cost information, the mutual interference of channels between nodes is measured. Therefore, the radio bandwidth is utilized efficiently, and the network throughput is improved.

Described below is the first embodiment of a gateway node under the disclosure.

FIG. 17 shows a structure of a gateway node in the first embodiment of the disclosure. The gateway node includes a location information querying module 151 and a location information sending module 152. Through the P2P network set up between the gateway nodes, the location information querying module 151 queries the information about the location of the data cache node which stores the data corresponding to the data request according to the data request received from the access router, and then the location information sending module 152 sends the location information to the access router.

In this embodiment, the location information querying module 151 queries the information about the location of the data cache node, and it is not necessary to send the routing broadcast message to obtain the location of the data cache node, thus saving the channels of the radio mesh network massively, utilizing the radio bandwidth efficiently, and improving the network throughput.

Described below is the second embodiment of a gateway node under the disclosure.

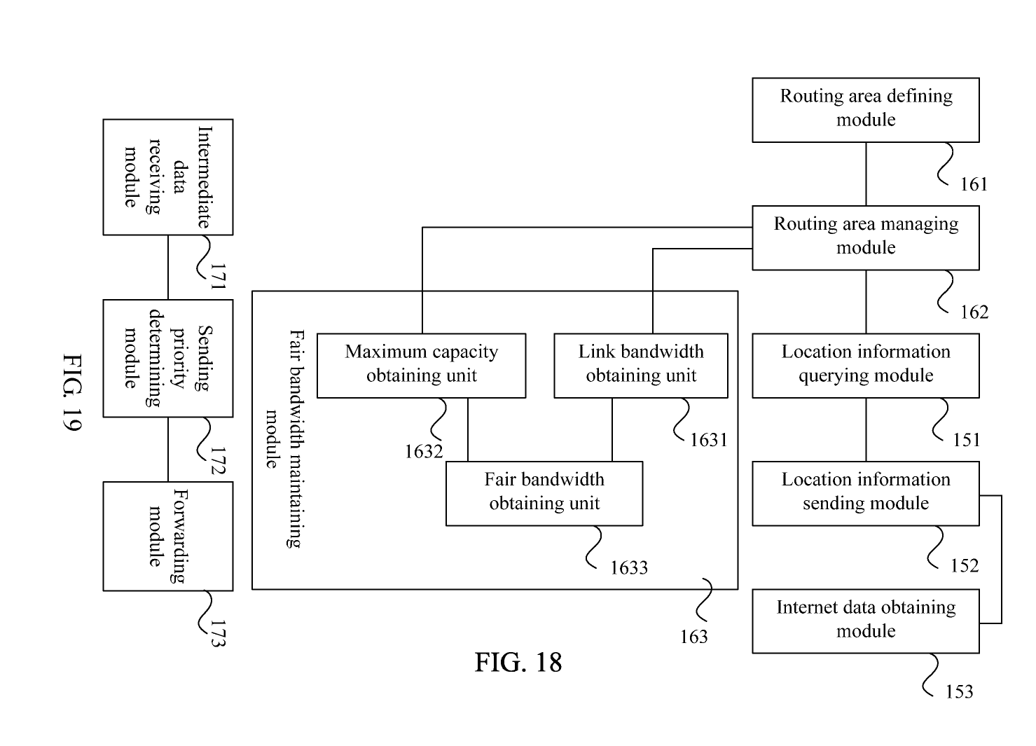

FIG. 18 shows a structure of a gateway node in the second embodiment of the disclosure. The gateway node may include: a routing area defining module 161, a routing area managing module 162, a location information querying module 151, a location information sending module 152, and a fair bandwidth maintaining module 163. The fair bandwidth maintaining module 163 may include: a link bandwidth obtaining unit 1631, a maximum capacity obtaining unit 1632, and a fair bandwidth obtaining unit 1633. The routing area defining module 161 sends a routing broadcast message. The router forwards the routing broadcast message which involves the minimum cost of routing from the gateway node that sends a routing broadcast message to the router. The routing area defining module 161 attaches the router to the gateway node which sends the routing broadcast message of the minimum cost, thus defining the routing area. The routing area managing module 162 sets up a P2P network between the gateway nodes, and registers the information about routing from other routers in the home routing area of the gateway node to the gateway node and the data information stored in the router and the gateway node into the P2P network. Through the P2P network set up between the gateway nodes, the location information querying module 151 queries the location of the data cache node which stores the data corresponding to the data request according to the data request received from the access router. The location information sending module 152 sends the location information to the access router. After the data request is received from the access router, if the location information querying module 151 fails to find the information about the location of the data cache node which stores the data corresponding to the data request in the P2P network set up between the gateway nodes, the Internet data obtaining module 153 obtains the data from the Internet directly, and sends the data to the access router. After the routing area defining module 161 defines the routing area and the routing area managing module 162 sets up a P2P network, the link bandwidth obtaining unit 1631 obtains the bandwidth of the link between the routers in the home routing area of the gateway node. The maximum capacity obtaining unit 1632 obtains the maximum capacity affected by the communication on the link between the routers. The fair bandwidth obtaining unit 1633 generates a fair bandwidth through the following formula according to the bandwidth and the maximum capacity, and sends the fair bandwidth to each router: Gₘₐₓ=B/Cₘₐₓ, where: Gₘₐₓ represents the fair bandwidth; B represents the bandwidth; and Cₘₐₓ represents the maximum capacity.

In this embodiment, the routing area defining module 161 defines a routing area, and the routing area managing module 162 registers the information about routing from other routers in the home routing area of the gateway node to the gateway node and the data information stored in the router and the gateway node into the P2P network set up between the gateway nodes. The location information querying module 151 queries the location of the data cache node in the P2P network. Therefore, the data request scope is expanded. Besides, the location information querying module 151 queries the location of the data cache node, and it is not necessary for the access router to send a routing broadcast message to obtain the location of the data cache node, thus saving the channel resources of the radio mesh network. The fair bandwidth maintaining module 163 obtains the fair bandwidth of the router in the routing area and allows for the load of the router, thus utilizing the radio bandwidth efficiently and improving the network throughput.

The data request method, the data sending method, the routing method and device, and the data cache system provided herein are also applicable to mobile self-organized networks and radio sensor networks for the purpose of a multi-path routing policy. The self-organized radio network without features of a center server uses the routing cost information to sort the routed data according to the sending priority, thus reducing potential radio conflict and improving the network throughput.

Described below is the first embodiment of an intermediate router under the disclosure.

FIG. 19 shows a structure of an intermediate router in the first embodiment of the disclosure. The intermediate router may include: an intermediate data receiving module 171, a sending priority determining module 172, and a forwarding module 173. The intermediate data receiving module 171 receives the data sent by the data cache node to the access router, where the data carries the information about the cost of routing from the access router to the data cache node. The sending priority determining module 172 determines the information about the sending priority of the data according to the routing cost information. The forwarding module 173 sends the data according to the sending priority information, and forwards the data with a higher sending priority first.

In this embodiment, the sending priority determining module 172 determines the sending priority of the data according to the information about the cost of routing from the access router to the data cache node, where the routing cost information is carried in the data; and the forwarding module 173 forwards the data according to the sending priority information and measures the mutual interference of channels between the routers through the routing cost information, thus utilizing the radio bandwidth efficiently and improving the network throughput.

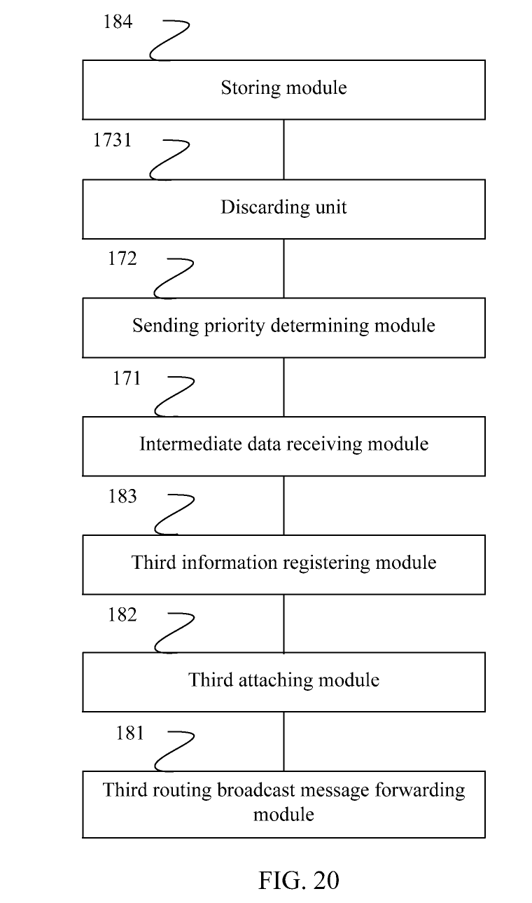

FIG. 20 shows a structure of an intermediate router in the second embodiment of the disclosure. The intermediate router may include: a third routing broadcast message forwarding module 181, a third attaching module 182, a third information registering module 183, an intermediate data receiving module 171, a sending priority determining module 172, a forwarding module 173, and a storing module 184. The forwarding module 173 includes a discarding unit 1731. The third routing broadcast message forwarding module 181 sends a routing broadcast message. The routing broadcast message involves the minimum cost of routing from the gateway node to the intermediate router among the routing broadcast messages sent by the gateway node to the intermediate router. Specifically, the cost may be the quantity of hops or other measures of the radio routing cost such as ETT or ETX. The third attaching module 182 determines the home routing area of the intermediate router according to the routing broadcast message that involves the minimum cost. The intermediate router attaches itself to the gateway node which sends the routing broadcast message that involves the minimum cost. In this way, a cluster which uses the gateway node as a cluster center is generated, and this cluster is a routing area. Through the gateway node in the home routing area of the intermediate router, the third information registering module 183 registers the information about routing from the intermediate router to the gateway node in the home routing area of the intermediate access router and the data information stored in the intermediate router into the P2P network which is set up between the gateway nodes and based on the distributed Hash table. The intermediate data receiving module 171 receives the data sent by the data cache node to the access router, where the data carries the information about the cost of routing from the access router to the data cache node. The sending priority determining module 172 determines the information about the sending priority of the data according to the routing cost information. If conflict or congestion occurs on the intermediate router, the discarding unit 1731 discards the data with a lower sending priority according to the fair bandwidth. The storing module 184 stores the data sent by the data cache node to the access router, thus improving the hit rate of the local cache.

In this embodiment, the third routing broadcast message forwarding module 181 forwards the routing broadcast message sent by the gateway node; the third attaching module 182 determines the home routing area of the intermediate router; and the third information registering module 183 registers the information about routing from the intermediate router to the gateway node in the home routing area of the intermediate router and the stored data information into the P2P network which is set up between the gateway nodes, thus facilitating the gateway node to search for data information. The sending priority determining module 172 determines the information about the sending priority of the data according to the information about the cost of routing of the data sent from the data cache node to the access router. If conflict or congestion occurs on the intermediate router, the discarding unit 1731 discards the data which goes beyond the fair bandwidth and is of a lower sending priority. The mutual interference of channels between the routers is measured through the routing cost information, thus utilizing the radio bandwidth efficiently and improving the network throughput.

What is claimed is:

1. A method for sending a message, comprising:
sending a data request received by an access router to a gateway node in a routing area of the access router;
receiving location information from the gateway node, wherein the location information identifies a data cache node obtained according to the data request;
obtaining routing cost information from the access router to the data cache node according to the location information; and
sending a data obtaining request to the data cache node, wherein the data obtaining request carries the routing cost information.

2. The method according to claim 1, wherein the obtaining routing cost information from the access router to the data cache node according to the location information comprises:
obtaining a routing path from the access router to the data cache node according to the location information, wherein the routing path includes at least one link;
obtaining a conflict routing cost of the link, wherein the conflict routing cost is the total quantity of the routers that can be monitored through the MAC layer by the two nodes on both sides of the link; and
obtaining the routing cost information according to the conflict routing cost of the link.

3. The method according to claim 1, wherein the sending a data request received by an access router to a gateway node in a routing area of the access router comprises:
sending a routing broadcast message, wherein the broadcast message is the message sent by the gateway node to the access router and the broadcast message involves the minimum cost of routing from the gateway node to the access router among the routing broadcast messages;
determining the home routing area of the access router according to the routing broadcast message that involves the minimum routing cost; and
registering the information of routing from the access router to the gateway node in the home routing area of the access router and the data information stored by the access router into a Peer-to-Peer (P2P) network via the gateway node in the home routing area of the access router, wherein the P2P network is set up between the gateway nodes based on the distributed Hash table.

4. The method according to claim 2, wherein the sending a data obtaining request to the data cache node comprises:
obtaining the cost of routing from the access router to the data cache node according to the routing path from the access router to the data cache node; and
sending a data obtaining request to the data cache node in spiral mode according to the cost, wherein the data obtaining request carries the routing cost information.

5. A method for sending data, comprising:
receiving data sent by a data cache node to an access router, wherein the data carries information about the cost of routing from the access router to the data cache node;
determining information about the sending priority of the data according to the routing cost information; and
sending the data according to the sending priority information.

6. The method according to claim 5, wherein the sending the data according to the sending priority information comprises:
discarding the data with a lower sending priority according to the fair bandwidth if a conflict or congestion occurs on the intermediate router.

7. The method according to claim 5, the method further comprising:
sending a routing broadcast message, wherein the routing broadcast message involves the minimum cost of routing from a gateway node to an intermediate router among the routing broadcast messages sent by the gateway node to the intermediate router;
determining the home routing area of the intermediate router according to the routing broadcast message that involves the minimum cost; and
registering the information of routing from the intermediate router to the gateway node in the home routing area of the intermediate access router and the data information stored in the intermediate router into the P2P network, wherein the P2P network is set up between the gateway nodes and based on the distributed Hash table.

8. An access router, comprising:
a data request forwarding module, adapted to send a data request received by the access router to a gateway node in a home routing area of the access router;
a routing cost obtaining module, adapted to receive location information from the gateway node, wherein the location information identifies a data cache node obtained according to the data request, and obtain information about the cost of routing from the access router to the data cache node according to the location information; and
a data obtaining request sending module, adapted to connect to the routing cost obtaining module and send a data obtaining request to the data cache node, wherein the data obtaining request carries the routing cost information.

9. The access router according to the claim 8, wherein the routing cost obtaining module comprises:
a location information receiving unit, adapted to receive a location information from the gateway node;
a routing path obtaining unit, adapted to obtain a routing path from the access router to the data cache node according to the location information, wherein the routing path includes at least one link;
a conflict routing cost obtaining unit, adapted to obtain a conflict routing cost of the link, wherein the conflict routing cost is the total quantity of the nodes that can be monitored through the MAC layer by the two nodes on both sides of the link; and
a routing cost obtaining unit, adapted to obtain the routing cost information according to the conflict routing cost of the link.

10. The access router according to the claim 8, wherein the access router further comprises:
a first routing broadcast message forwarding module, adapted to send a routing broadcast message, wherein the routing broadcast message involves the minimum cost of routing from the gateway node to the access router among the routing broadcast messages sent from the gateway node to the access router;
a first attaching module, adapted to determine the home routing area of the access router according to the routing broadcast message that involves the minimum cost; and
a first information registering module, adapted to register the information about routing from the access router to the gateway node in the home routing area of the access router and the data information stored in the access router into the P2P network, wherein the P2P network is set up between the gateway nodes and based on the distributed Hash table.

11. The access router according to the claim 8, wherein the access router further comprises:
a data forwarding module, adapted to send the data to the terminal after the access router receives the data request from the terminal if any data corresponding to the data request is stored in the access router.

12. The access router according to the claim 8, wherein the data obtaining request sending module comprises:
a routing cost obtaining module, adapted to receive the location information from the gateway node, wherein the location information identifies the data cache node obtained according to the data request, and obtain the information about the cost of routing from the access router to the data cache node according to the location information; and
a data obtaining request sending module, adapted to send a data obtaining request to the data cache node, wherein the data obtaining request carries the routing cost information.

13. A data cache system, comprising:
at least one access router covered by at least one routing area, at least one intermediate router, at least one data cache node, and at least one gateway node; wherein a P2P network is set up between the gateway nodes; and the information registered on the P2P network includes the information about routing from the access router, the intermediate router and the data cache node to the gateway node in the home routing area, and includes the data information stored on the access router, the intermediate router, the data cache node, and the gateway node; wherein
the access router is adapted to send a received data request to the gateway node, receive location information from the gateway node, wherein the location information identifies the data cache node obtained according to the data request, and obtain the information about the cost of routing from the access router to the data cache node according to the location information, and send a data obtaining request to the data cache node, where the data obtaining request carries the routing cost information;
the gateway node is adapted to search the P2P network for information about the location of the data cache node which stores the data corresponding to the data request, and send the location information to the access router;
the data cache node is adapted to receive the data obtaining request from the access router, and send the data corresponding to the data obtaining request to the access router, wherein the data carries the routing cost information; and
the intermediate router is adapted to receive the data sent by the data cache node to the access router, determine information about the sending priority of the data according to the routing cost information carried in the data, and send the data according to the sending priority information.
